(19) United States
(12) Patent Application Publication
(10) Pub. No.: US 2004/0050795 A1
(43) Pub. Date: Mar. 18, 2004

(54) Removal of arsenic and other anions using novel adsorbents

(76) Inventors: Jae Kwang Park, Madison, WI (US); Min Jang, Madison, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 10/664,300

(22) Filed: Sep. 17, 2003

Related U.S. Application Data
(60) Provisional application No. 60/411,610, filed on Sep. 18, 2002.

(51) Int. Cl. C02F 1/28

(52) U.S. Cl. 210/681

(57) ABSTRACT

To more effectively remove contaminants from fluid streams, several types of metal precursors can be incorporated onto highly ordered mesoporous molecular sieves, such as SBA-15, without producing of clogging effects within pore structures. Lanthanum and aluminum are the most favorable incorporated metals in terms of their adsorption capacities and fluid velocities. The lanthanum impregnated SBA-15 also has a very strong selectivity for arsenic because its adsorption capacities do not deteriorate even if several other anionic species, such as sulfate and nitrate, are found in high concentrations in the fluid along with any arsenic. As a result, these hybrid materials have many advantages for use in POE/POU applications, among others, due to its rapid and high adsorption capacity, and its high selectivity of arsenic for removal from the fluid stream.

### CROSS REFERENCE TO RELATED APPLICATIONS

This application claims priority from U.S. Provisional Patent Application Serial No. 60/411,610, which was filed on Sep. 18, 2002.

### STATEMENT REGARDING FEDERALLY SPONSORED R & D

This invention was made with United States government support awarded by the following agencies:

USDA/FS 99-RJVA-3237.

The United States has certain rights in this invention.

### FIELD OF THE INVENTION

The present invention relates to a method of removing arsenic from water and more specifically to a method of removing arsenic using a novel adsorbent formed of a metal impregnated mesoporous silicate molecular sieve.

### BACKGROUND OF THE INVENTION

Throughout the world, arsenic creates potentially serious environmental problems for humans and other living organisms. Most reported arsenic problems in water supply systems have been found in groundwater, usually the primary drinking water source in rural areas, and are mainly caused by various human activities and their waste products, such as mining wastes, petroleum refining, sewage sludges, agricultural chemicals, ceramic manufacturing industries and coal fly ash. However, arsenic problems can also be the result of certain natural causes that include mineral weathering and dissolution caused by the changes of geo-chemical environments to reductive conditions.

Due to the recent reduction in the regulation limit of arsenic contamination from 50 to 10 ppb, small public water systems will face heavy financial burdens as a result of complying with the much more stringent limits on arsenic based on the methods and systems currently available for the removal of arsenic from water whether the water is for public consumption or is simply waste water generated by some industrial process.

Therefore, a new highly effective, reliable, and economical technique is needed to meet the new lowered arsenic maximum contaminant level. Compared to other known techniques, arsenic removal systems using adsorption usually do not take up a large amount of space or require additional chemicals for treatment of the water, and do not generate sludge that must be disposed of. As a result, an adsorption system is very easy to set up as a POE/POU (Point of Entry/Point of Use) process system. For those POE/POU systems currently in use, activated alumina is one of the best available adsorbents and has been extensively studied because it is very effective and selective for arsenic adsorption removal. For example, U.S. Pat. No. 5,556,545 discloses an arsenic removal method in which activated alumina is used in an adsorption process and micro-filtration is involved to separate the activated alumina. Further, U.S. Pat. No. 6,030,537 describes a method for removing arsenic from aqueous solutions with an adsorbent made of a mixture of activated bauxite and aluminum trihydrate. In the '537 patent it is also disclosed that the combination of activated bauxite and aluminum trihydrate shows a synergistic effect by removing arsenic with higher adsorption capacities than either activated bauxite or aluminum trihydrate alone. However, the highly alkaline feeding solution needs to be controlled with an acidic solution to have pH 5.5˜6.0 to achieve the optimum arsenic adsorption capacity of the activated alumina. In addition, when the activated alumina is regenerated, its adsorption capacity will be reduced by 20˜50% per instance of regeneration, greatly reducing the effectiveness of the alumina after just one use. Furthermore, because of the slower adsorption reaction, activated alumina should have relatively longer empty bed contact time than ion exchange resins.

As an alternative to activated alumina, lanthanum oxide is known as a highly active metal oxide useful in adsorbing anionic species from an aqueous solution. For example, U.S. Pat. No. 6,197,201 B1 discloses that lanthanum chloride is a very good reagent for use in precipitating arsenic and selenium ions from an aqueous solution at various pH conditions. In the '201 patent it is also suggested that the lanthanum chloride can be used in combination with ferrous or ferric sulfate to achieve the highest level of arsenic and selenium removal. Further, U.S. Pat. No. 5,603,838 discloses the use of lanthanum oxide to remove selenium and arsenic from aqueous streams. It was found that the lanthanum and the composition with alumina had higher adsorption capacities for arsenic than activated alumina.

The M41S family of mesoporous silicate molecular sieves, developed by Mobil scientists in 1992, and similar materials has opened up new possibilities in the fields of catalysis, sensors, and adsorbents. These materials are synthesized with a self-assembled molecular array of surfactant molecules as a structure-directing template, which results in very sharp and ordered pore distributions of inorganic materials. These materials can be classified with different pore structures as following MCM-41 (two dimensional hexagonal mesopore structure), MCM-48 (three dimensional cubic mesopore structure), and MCM-50 (lamellar mesopore structure).

The newly developed mesoporous silica molecular sieves, so called SBA-15, have been successfully synthesized using amphiphilic triblock copolymers as a structure-directing template agent under hydrothermal conditions. These SBA-15 molecular sieves have uniform two dimensional hexagonal (space group p6mm) mesopore channels that can be tailored in size by changing the synthesis conditions. Compared with the M41S types which were developed by Mobil scientists, the mesoporous silica SBA-15 molecular sieve has larger pore sizes of about 40˜100 Å without the use of pore expanding chemicals, so that it can likely incorporate a large amount of a metal precursor without any resulting clogging effects occurring within the pores. In addition, water or ethanol extraction can be applied to recover the pore-forming template for reuse in SBA-15 synthesis due to the weak interaction between two dimensional hexagonal silica and triblock copolymer mesophases.

Through various incorporation techniques, organic and/or inorganic materials can be functionalized onto the monolayer of the highly ordered nano-structured materials that have a very large amount of surface area in a very small volume to make highly active sites for use in adsorption, catalysis, or sensoring applications. Up to now, due to their advanced characteristics, the incorporation of various functional materials into mesoporous materials has been spotlighted in terms of synthesis, mechanism, and applications.

### SUMMARY OF THE INVENTION

The objectives of the present invention are to provide novel adsorbents with high arsenic adsorption capacities created by synthesizing highly ordered mesoporous silica sieves and incorporating nano-particles of metal oxides into the mesopores by use of a suitable method, such as an incipient-wetness impregnation technique. The adsorption capacities for arsenic species of these impregnated adsorbents were evaluated through adsorption kinetics and isotherm studies with different conditions for the various metal oxides incorporated into the mesoporous molecular sieves.

In the present invention, highly active additives, such as metal oxides including iron (II) oxide, iron (III) oxide, titanium oxide, lanthanum oxide and aluminum oxide, were incorporated into the mesopores of mesoporous silica sieves for use in removing arsenic species from aqueous phases. These active metal oxides were dispersed homogeneously within the sieves to make a higher number of active sites within the majority of the mesopores in the media. The adsorbent formed in this manner can be recovered or regenerated easily with an extractant such as sodium hydroxide solution in a known method to regenerate the media because the media has very ordered wide mesoporous structures.

Using an amphiphilic triblock copolymer, a highly ordered mesoporous silica oxide, e.g., SBA-15, was synthesized for use as the nano-structured highly ordered mesoporous supporter for a number of highly active metal oxides that are capable of removing arsenic species from ground or surface water. Using an incipient-wetness impregnation technique, 5˜140% of the metals (based on the mass of the sieve) were incorporated and oxidized safely into the silica oxide of the sieve without any resultant choking or plugging of the pore structures in the sieve. When compared with activated alumina, which is mainly used for arsenic removal, a mesoporous silica sieve incorporated with metal oxides showed marked increases in adsorption capacity for a broad range of initial arsenic concentrations. According to the kinetic analysis, arsenic adsorption for the impregnated molecular sieves also followed both pseudo second order and parabolic diffusion kinetic models with very fast adsorption velocity. Specifically, compared to activated alumina, the aluminum impregnated molecular sieve showed the higher q_{eq} and v₀ values by fitting with pseudo-2nd order equation. The As(V) adsorption capacities of the aluminum-impregnated sieves decreased linearly with an increase in pH, while activated alumina did not show any large changes in adsorption capacities.

Further, lanthanum-impregnated sieves exhibited higher adsorption capacities due to the higher pH of zero charge (PZC) and the homogeneous distribution within the pore structures. The lanthanum-impregnated sieves showed very fast kinetic velocities of arsenic removal, fitting well with the simple elovich equation. For example, with bottled water, the lanthanum-impregnated sieves showed greatest adsorption capacity of above 80 mg/g.

As a result, the lanthanum-impregnated sieves exhibit highly improved arsenic removal capacities for POE/POU systems as well as in the removal of arsenic from waste water generated by various industrial processes, such as the drainage created by acid mining, for example.

### BRIEF DESCRIPTION OF THE DRAWINGS

The drawings illustrate the best mode currently contemplated of practicing the present invention.

In the drawings:

FIG. 1 is a graph of the adsorption isotherm data of activated alumina and 10% aluminum impregnated mesoporous silica under various pH conditions at an equilibrium state;

FIG. 2 is a graph of the results of conductivity tests of lanthanum-impregnated molecular sieves and lanthanum-impregnated granular activated carbon with different percentages of impregnated lanthanum;

FIG. 3A is a photomicrograph of a lanthanum-impregnated molecular sieve with 10% impregnation of lanthanum by weight;

FIG. 3B is a photomicrograph of a lanthanum-impregnated molecular sieve with 20% impregnation of lanthanum by weight;

FIG. 3C is a photomicrograph of a lanthanum-impregnated molecular sieve with 80% impregnation of lanthanum by weight;

FIG. 4 is a box plot of the pore size distribution of a molecular sieve impregnated with 10% and 20% by weight of lanthanum;

FIG. 5 is a graph of the kinetics of arsenate adsorption at pH 7.2±0.02 with an initial arsenic concentration of 0.133 mmol for activated alumina, and molecular sieve impregnated with percentages of aluminum and lanthanum; and

FIG. 6 is a graph of the arsenate adsorption isotherms for activated alumina and a molecular sieve impregnated with various percentages of lanthanum.

### DETAILED DESCRIPTION OF THE INVENTION

I. Synthesis of the Molecular Sieve Material

Mesoporous silica, such as SBA-15 molecular sieve, has recently been developed with larger pore sizes of about 40˜100 Å without the use of a pore expanding chemical that increases the pore size while reducing the integrity of the sieve. For SBA-15 synthesis, amphiphilic triblock copolymers are used to direct the mesoporous structure of silica. It is usually synthesized in an acidic medium, i.e., pH<7, in which two dimensional hexagonal (space group p6 mm) silica and triblock copolymer mesophases are formed.

Using one of several incorporation techniques available, organic and/or inorganic materials can be functionalized onto the monolayer of the highly ordered nano-structured materials which upon formation have a very large amount of surface area in a very small volume of the materials. The incorporation techniques preferred for use in incorporating the various metal precursors, i.e., metal oxides, into the materials used in the present invention are the incipient-wetness and wetness impregnation techniques.

A. Synthesis Method of Powdered Adsorbents

For the purposes of the present invention, the mesoporous silica sieve, e.g., the SBA-15 is prepared using a triblock copolymer, such as Pluronic P123, EO₂₀PO₇₀EO₂₀ as a structure directing reagent and tetraethyl orthosilicate (TEOS) as a silica precursor. In this preferred procedure, initially 4 grams of the triblock copolymer are dissolved in 60 mL of deionized water for 30 minutes. Then, 120 mL of a 2 M hydrochloric acid solution is added to the water/copolymer mixture. The solution is then stirred continuously for 30 minutes. Next, 9.1 mL of the TEOS is added to the mixture. The resulting mixture is then heated at 30˜45° C. for 20 hours. The mixture is then transferred into a Teflon® bottle and heated at 80˜100° C. for 24 hours without stirring. After that, the resulting solid product is filtered with a 0.45-μm filter paper and dried at room temperature under a vacuum hood prior to calcination. The mol fraction of each of the components of the as-synthesized SBA-15 is 1 mol TEOS: 5.854 mol HCl: 162.681 mol H₂O: 0.0168 mol triblock copolymer. The calcination of the adsorbent is performed in an oven at 550˜600° C. for 4 hours in air to remove the organic components of the triblock copolymer. The calcined SBA-15 is preserved at room temperature under a vacuum hood.

B. Incipient Wetness Impregnation Technique

Using the incipient impregnation technique, Al(NO₃)₃.9H₂O and La(NO₃)₃.×H₂O (where x=3˜5) are used as aluminum and lanthanum precursors for incorporation into the SBA-15. In the preferred embodiment of the technique, an aliquot of 200-μL aluminum or lanthanum precursor solution is evenly dispersed using a 200-μL micropipette over 1 gram of the calcined SBA-15 placed into a mortar. The mixture is homogeneously mixed in the mortar with a pestle for approximately 5 minutes. This procedure of adding 200-μL of the metal precursor solution to the mortar is repeated until the ratio of the metal precursor solution volume (mL) and SBA-15 mass (grams) is 2:1. The final mixture is then dried under a vacuum hood at room temperature for I day. The solids left over are then calcined in an oven with a programmed temperature increase from room temperature to 400˜600° C. with the speed of 0.5˜1.0° C. per minute. After calcination, the resulting impregnated solids are kept within the vacuum chamber or hood.

C. Wetness Impregnation Technique

For the wetness impregnation technique, in a preferred method each metal precursor is dissolved in an amount of deionized water to arrive at a desired concentration of the precursor in the solution. An aliquot of 30 mL of the precursor solution is then stirred with 1 gram of the previously prepared SBA-15 for 10 minutes. The SBA-15 is impregnated with the metal from the precursor and the resulting solid is filtered with a 0.45-μm filter and dried at room temperature under a vacuum hood for several hours. The calcination of the dried solid is then performed in the same manner as described regarding the incipient wetness impregnation technique.

D. Synthesis Method for Granular-Sized Adsorbents

To prepare the adsorbent of the present invention for use in column mode, granular sized adsorbent media is made by the oil drop method which was proposed by Buelna and Lin (Buelna and Lin, “Preparation of Spherical Alumina and Copper Oxide Coated Alumina Sorbents by Improved Sol-Gel Granulation Process,” 42, Microporous and Mesoporous Materials 67-76 (2001)). More specifically, after all the components of the adsorbent, namely the triblock copolymer, the TEOS and water, are mixed in a container maintained at hydrothermal conditions at between 30 and 90° C. for approximately 10˜30 hours, and then, the resulting sol is transferred using a conventional peristaltic pump to a sol dropper. Droplets of a small size, i.e., less than 0.1 -mm in diameter, are then dropped down from 0.1 -mm diameter nozzles into 5˜30 cm of paraffin oil layer which has a density of 0.84 g/mL, thus forming spherical gel particles caused by the surface tension of the mineral oil. Then, the gel particles fall into an aqueous solution of 10% NH₃ and are aged therein for 1 hour. The granular sized gel particles are subsequently washed with deionized water. Then, the gel particles are placed in a microwave system to make a rapid and homogeneous condensation of the particles. After condensation, the solid pore template agent is removed either through calcination or solvent extraction, in which tepid water or ethanol is used as an extracting agent. Subsequently, using the wetness impregnation technique, lanthanum is incorporated into the mesoporous media and oxidized under the conditions stated with regard to the previous processes.

II. Experimental Procedures

A. Conductivity Tests

After incorporating the selected metal precursors with various weight percentages in one of the methods described previously, conductivity tests were performed on the media to confirm the oxidation of the precursor and the adherence of the precursor to the media. In this testing procedure, exactly 0.02 g of the particular metal impregnated mesoporous silica was washed with 5 mL of deionized water and filtered through a 0.45-μm pre-rinsed Uniflo filter unit. The conductivity of the filtrate was then analyzed with a conductance meter, such as a YSI Model 32.

B. Arsenic Adsorption Isotherm Tests

In performing the adsorption isotherm tests, sodium arsenate (Na₂HAsO₄.7H₂O) obtained from Sigma Aldrich was used as the arsenic source without any modification. A stock arsenic solution was prepared with the sodium arsenate and deionized water to make an arsenate solution of 133 mmol As/L. To test for adsorption, 50˜100 mL of a NaNO₃ (0.01 M) solution prepared with deionized water was poured into a polyethylene bottle of a known volume. Then, a small volume, e.g., 0˜0.5 mL of the arsenic stock solution was added to the bottle to achieve the pre-determined arsenic concentrations of 0˜1.33 mmol/L and the pH of suspension was adjusted to a pH of about 4.5˜9.0 with an automatic pH titrator (Model 48pH 1/16 DIN pH controller, EXTECH®). All samples were set into a rotary shaker and shaken at 250 rpm. The shaking temperature was 25±0.5° C. throughout the shaking process. After 8 hours of continuous shaking, the pH of samples was readjusted to within the specified range with the automatic pH titrator, using small volumes of acid and base stock solution. All samples then were reset in the rotary shaker to achieve an equilibrium state. After 24 hours of continuous shaking, 5 mL of the suspension was withdrawn and filtered immediately with a 0.45 μm pre-rinsed Uniflo filter unit and the filtrate was analyzed for the arsenic concentration of the solution. All data of the arsenic adsorption isotherm were fitted with Freundlich and Langmuir isotherm models.

C. Arsenic Adsorption Kinetic Studies

In performing the adsorption kinetic studies, an amount of an arsenic stock solution was prepared in the same manner as for the adsorption isotherm tests. An aliquot of 300 mL of deionized water was prepared with a solution having a concentration of 0.01 mmol/L of NaNO₃ and poured into a reaction bottle for each kinetic study. After injecting a small volume, e.g., 300 μL of the arsenic stock solution into the bottle to make the desired arsenic concentration within the solution contained in the bottle, the suspension was stirred with 500 rpm of stirring velocity on a magnetic stirrer. The pH of the solution was adjusted to within the pH range of 7.2±0.02 with the automatic pH titrator and the temperature was maintained at 25±0.5° C. for one hour before the adsorbent was injected in an amount of between 0.05 to 0.1 gram. In order to maintain a relatively constant pH condition within the specified pH range during the kinetic studies, the automatic titrator was set up in the reactor, connected to a pH electrode and a pair of small tubes coming from two peristaltic pumps capable of supplying small volumes of either an acid (e.g., HNO₃, 0.1 M) or base (e.g., NaOH, 0.1 M) stock solution. One of the two pumps for the acid and base stock solutions was operated when the pH drifted ±0.02 pH units from the initial pH. An aliquot of 3 mL of the adsorbent suspension in the reactor was withdrawn with sequential 2˜60 minute periods and filtered through a 0.45 μm-Uniflo pre-rinsed filter unit for arsenic analysis.

Activated alumina obtained from Sigma-Aldrich was selected to compare the adsorption isotherm and kinetic data with both aluminum and lanthanum impregnated SBA-15.

Arsenic concentrations were analyzed with a Varian AA-975 Atomic Absorption Spectrophotometer (AAS) and GTA-95 Graphite Tube Atomizer with programmable sample dispenser. As a matrix modifier, a 50 mg/L nickel solution was used in each case.

### EXPERIMENTAL

The following are examples of the above testing procedures illustrating the results obtained for aluminum and lanthanum impregnated mesoporous silica in comparison with other standard compounds used for the removal of arsenic.

### EXAMPLE 1

Arsenic Removal by Aluminum Impregnated SBA-15

To determine the adsorption capacities of Al₁₀SBA-15 and activated alumina, adsorption isotherm tests were performed with a low arsenic concentration of 0.133 mmol/L or 10 mg/L. The solution volume was 100 mL and masses of both adsorbents were varied. The resulting filtrate was analyzed for the arsenic concentration of the solution using AAS-graphite methods as is known. The final pH was fixed at 6.55±0.02. From fitting data with the Freundlich isotherm, the arsenic adsorption capacity of Al₁₀SBA-15 was determined to be (13.9 mg_{As}/g, 0.185 mmol/g), which is 2.2 times greater than that of activated alumina (6.3 mg_{As}/g, 0.084 mmol_{As}/g) at a 0.1 mmol/L initial arsenic concentration. Based on the mole fraction of arsenic and each metal compound, the observed adsorption densities for activated alumina and Al₁₀SBA-15 were 0.00857 mmol_{As}/mmol_{Al} and 0.05 mmol_{As}/mmol_{Al}, respectively, at a 0.1 mmol/L initial arsenic concentration. The fitting parameters and determination coefficient R² values for activated alumina and Al₁₀SBA-15 are summarized as follows in Table 1.

TABLE 1
Determination Coefficients (R²) and Parameters for the Fit of
Arsenate Adsorption Isotherm Data to Both Freundlich and
Langmuir Isotherms

| Adsorption isotherms and | | Activated | |
|---|---|---|---|
| parameters | | alumina | Al₁₀SBA-15 |
| Langmuir¹ | b | 1049.88 | 3518.82 |
| | Qₘₐₓ(mmol_{As}/g) | 0.120 | 0.283 |
| | Qₘₐₓ(mg_{As}/g) | 9.0 | 21.2 |
| | R² | 0.765 | 0.933 |
| Freundlich² | K | 0.291 | 0.455 |
| | n | 0.269 | 0.196 |
| | R² | 0.924 | 0.960 |

${}^{1} Langmuir isotherm \text{:} {q}_{eq} = \frac{{bQ}_{max} {C}_{eq}}{1 + {bC}_{eq}}$
${}^{2} Freundlich isotherm \text{:} {q}_{eq} = {KC}_{eq}^{1 / n}$

### EXAMPLE 2

Solution pH Effects for Arsenic Removal by Aluminum 10% Impregnated Impregnated SBA-15 (Al₁₀SBA-15)

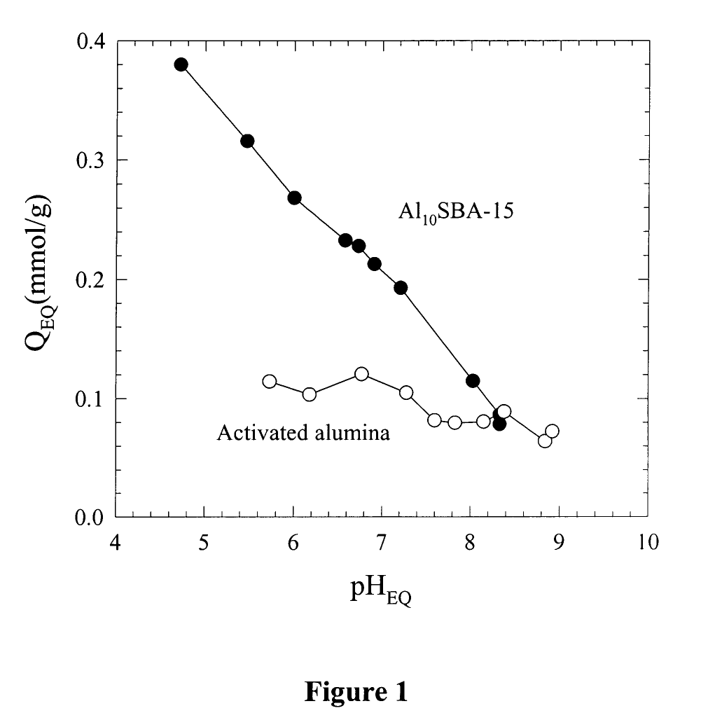

FIG. 1 shows the adsorption isotherm data of activated alumina and Al₁₀SBA-15 under different pH conditions at an equilibrium state. As illustrated, the arsenic adsorption capacities of Al₁₀SBA-15 linearly increases with decreases in pH, while activated alumina did not show any significant changes in adsorption capacities with changes in pH. Further, at pH 7.0, Al₁₀SBA-15 had about 15 mg_{As}/g (0.2 mmol_{As}/g) of adsorption capacity, which is twice as large as that found for activated alumina. Even though the resulting adsorption capacities of Al₁₀SBA-15 were much greater than other previous adsorption studies, the adsorption tendency of Al₁₀SBA-15 under different pH conditions at equilibrium was very similar to the other studies' equilibrium, in which oxyanion adsorption on goethite was investigated. This result suggests that Al₁₀SBA-15 has inner-sphere complexes for arsenic adsorption similar to other studies. The presence of these inner-sphere complexes can be explained by the fact that oxyanions are bonded covalently with the reactive functional groups on the surface without a hydration reaction.

### EXAMPLE 3

Kinetic Studies of Arsenic Removal by Aluminum 10% Impregnated Impregnated SBA-15 (Al₁₀SBA-15)

Arsenic adsorption kinetics were conducted for activated alumina, Al₅SBA-15, Al₁₀SBA-15, and Al₁₅SBA-15. Their fitting lines of the pseudo second order kinetic model had high determination coefficient (R²) values for all of the data. Compared with activated alumina, Al₁₀SBA-15 had a very fast arsenic adsorption rate, in which equilibrium was reached within 1 hr. In addition, the adsorption capacity of Al₁₀SBA-15 was twice as great as that of activated alumina. Al₁₀SBA-15 showed the highest adsorption rate and capacity in all of the different metal impregnation percentages, even if arsenic adsorption capacities for the rest of the aluminum impregnated SBA-15 solids decreased with higher solid concentration, which had the same phenomena as the adsorption isotherm data fitted with the Freundlich isotherm model. For example, Al_{2.5}SBA-15 (2.5% w/w Al) and Al₅SBA-15 (5% w/w Al) had lower adsorption capacity (in mmol_{As}/g) than activated alumina. Also, Al₁₅SBA-15 (15% w/w Al) had slightly higher adsorption capacity than activated alumina but much lower than Al₁₀SBA-15 at 0.333 g/L solid concentration. More specifically, the initial sorption rate and k_{diff} of Al₁₅SBA-15 were 0.0128 (mmol·g⁻¹·min⁻¹) and 0.457 (min^{-0.5}), respectively. The initial sorption rate of Al₁₀SBA-15 (0.0824 mmol·g⁻¹·min⁻¹) was 15 times greater than that of activated alumina (0.0054 mmol·g⁻¹·min⁻¹) at 0.333 g/L solid concentration. These results show great advantages of Al₁₀SBA-15 for POE/POU applications due to its rapid and high adsorption capacity.

### EXAMPLE 4

Arsenic Removal and Characterization of Lanthanum Impregnated SBA-15

After lanthanum in an amount of 80% by weight of the SBA-15 was impregnated into SBA-15 using one of the two previously described methods, conductivity tests were performed on the impregnated SBA-15 to confirm the oxidation of lanthanum precursor with different calcinations temperatures in the range of 300˜550° C. More specifically, 0.02 gram of each material was washed with 5 mL of deionized water and filtered with a 0.45 μm pre-washed Uniflo filter unit. The conductivity of filtrate was analyzed with a conductance-meter, such as a YSI model 32. With the increase of the calcination temperature, the conductivity was decreased because more of lanthanum ions were oxidized as a result of the higher temperature. For example, the conductivity of material treated with 550° C. was the same with that of deionized water. Therefore, all of the LaSBA-15 used in all subsequent experiments was synthesized using a temperature of 550° C.

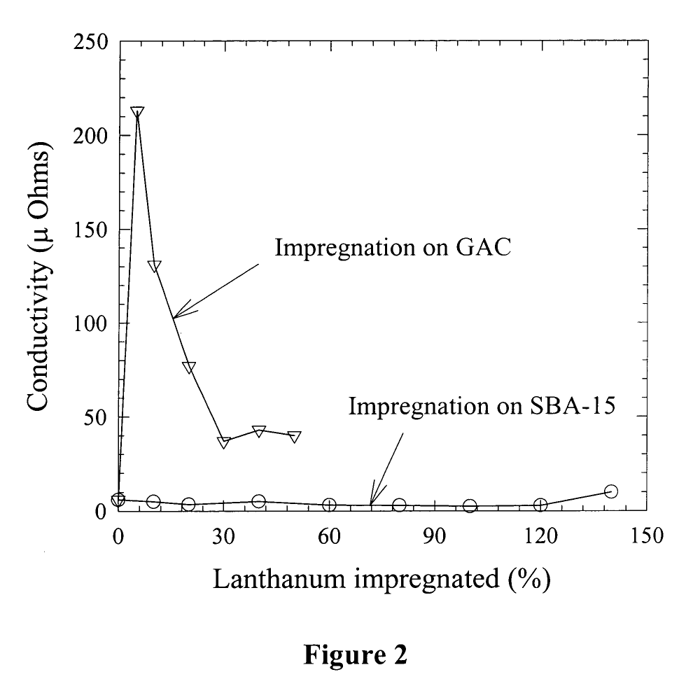

FIG. 2 shows the results of conductivity for a number of percentages of lanthanum impregnated SBA-15 and granular activated carbon (GAC). GAC was used as a substrate for comparison of lanthanum incorporation between SBA-15 and GAC. Except for the sample of 140% by weight lanthanum-impregnated SBA-15, lower lanthanum impregnation percentages had very good oxidation stabilities. However, high conductivity measurements for GAC samples impregnated with different weight % of lanthanum were shown because GAC could not supply the hydroxyl groups which are the active sites to which the lanthanum ions are linked.

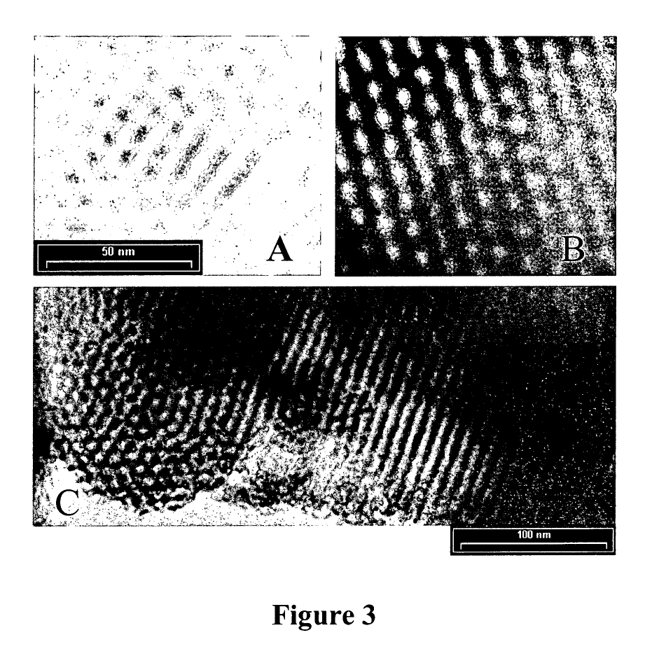

Each of the photomicrographs shown in FIGS. 3A-3C, was recorded with Philips CM200 UT Intermediate Voltage HRTEM (High Resolution Transmission Electron Microscope) operating at 200 kV. All solid samples were homogeneously dispersed in alcohol, then, the slurries were deposited onto the copper grid and dried in the hood at room temperature for 1 day. Bright spots are pore structures and dark sides are silica walls. FIG. 3A illustrates La₁₀SBA-15, FIG. 3B illustrates La₂₀SBA-15, and FIG. 3C shows La₈₀SBA-15.

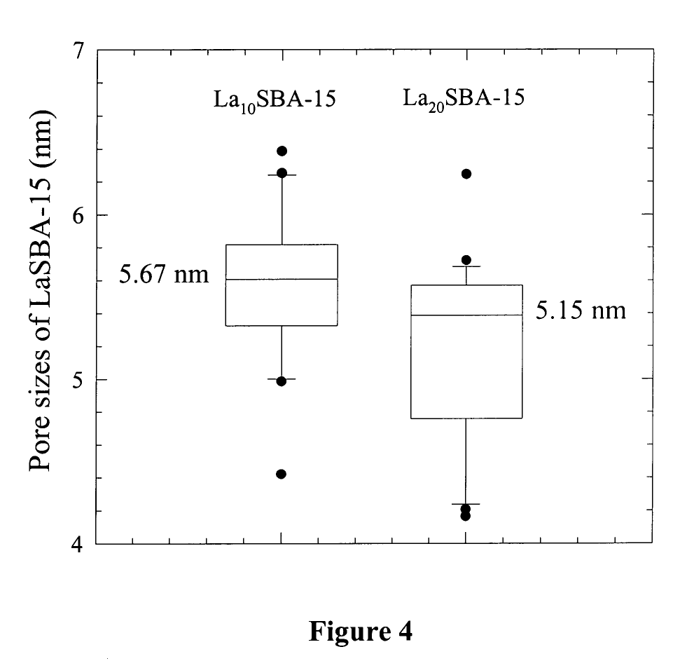

FIGS. 3A and 3B are photomicrographs showing top views of pore structures for both La₁₀SBA-15 and La₂₀SBA-15, respectively. FIG. 3C is a photomicrograph showing a side view of ordered 2 dimensional hexagonal uniform channel arrays in the SBA-15. The wall thickness of La₁₀SBA-15 was in the range of 40˜50 Å, which are very thick to sustain a hydrothermal condition. All pore sizes of each sample were measured using Image-Pro Plus image processing software developed by Media Cybernetics®. The pore size distributions for the micrographs in FIGS. 3A and 3B were obtained to draw the box plot shown in FIG. 4. The mean pore sizes of both La₁₀SBA-15 and La₂₀SBA-15 were estimated to be 5.67 nm and 5.15 nm, respectively. However, the data distribution of La₂₀SBA-15 was more skewed to have smaller pore sizes than La₁₀SBA-15, showing heterogeneous incorporation.

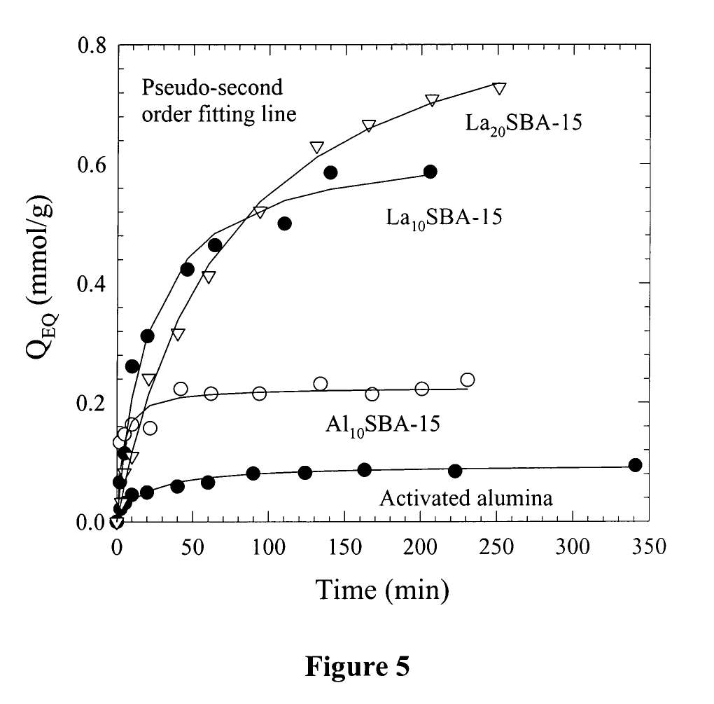

La₁₀SBA-15 and La₂₀SBA-15 showed much greater adsorption capacities than Al₁₀SBA-15. This is illustrated in FIG. 5 which graphically shows the kinetic data and pseudo 2^{nd} order kinetic model fitting line for activated alumina, Al₁₀SBA-15, La₁₀SBA-15 and La₂₀SBA-15. From the fitting results, La₂₀SBA-15 had 0.945 mmol/g or 70.8 mg/g of arsenic adsorption capacity, which is about 10-fold higher adsorption capacity than that of activated alumina. In terms of adsorption rate, La₁₀SBA-15 had faster arsenic adsorption rate than La₂₀SBA-15.

Granular activated alumina (AA-400G, ALCAN®) was selected as a commercialized product for arsenic removal in order to compare the adsorption isotherm and kinetic data for the activated aluminum with similar data collected from testing done with SBA-15 impregnated with various amounts or percentages of lanthanum. The specific surface area of activated alumina used in the tests was 350˜380 m²/g. A pseudo-second order kinetic model was applied to the kinetic data collected in testing on the activated alumina and the lanthanum-impregnated SBA-15 to obtain several parameters such as determination coefficients (R²), initial sorption rate (ν₀), q_{eq}, arsenate adsorption density (mmol_{As}/mmol_{Me}) and arsenate surface loading (mmol_{As}/m², BET), which are shown below in Table 2. In comparison with activated alumina, more rapid and higher sorption capacities were obtained with all of the samples of lanthanum impregnated SBA-15, regardless of the percentage of impregnation. Further, while the q_{eq} values obtained by the pseudo-second order kinetic model for most kinetic data of all media types were overestimated due to a few points of data obtained at extended times of more than 400 minutes, the resulting trend of adsorption capacities was determined to be similar to the trend of arsenate adsorption capacities at 400 minutes (designated to q₍ₜ₌₄₀₀₎). The q₍ₜ₌₄₀₀₎ values linearly increased to 124.4 mg_{As}/g with an increase of lanthanum impregnation up to 50%, however, with a slight decrease to 115.4 mg_{As}/g at 80% lanthanum impregnation. Similarly, the initial sorption rate sharply increased to 1.21 mg·g⁻¹·min⁻¹ at 20% and further increased to 1.71 mg·g⁻¹·min⁻¹ at 50%, but decreased to 1.53 mg·g⁻¹·min⁻¹ at 80%. The arsenate surface loading linearly increased as the lanthanum impregnated percentages increased while arsenate adsorption densities increased up to 50% of lanthanum impregnation, however, abruptly decreased with 80%. As a result of the kinetic studies, the most efficient percentage of lanthanum impregnation was 50% in terms of arsenate adsorption speed and capacity. La₅₀SBA-15 also had about 10, 38, and 13 times higher values for q₍ₜ₌₄₀₀₎ (mg_{As}/g), arsenate adsorption density (mmol_{As}/mmol_{Me}), and surface loading (mmol_{As}/m²), respectively, than activated alumina. Although the active sites of activated alumina might be larger than that of La₅₀SBA-15 due to a larger surface area, it was surmised with the following explanation that the lanthanum oxide incorporated in the SBA-15 was much more active in adsorbing the arsenate than the activated alumina in terms of physical and chemical properties of each compound. First, a large number of active sites for arsenate removal were achieved by the nano-scale dispersion of lanthanum precursors onto the highly ordered mesopore structures present in the SBA-15. Second, since most lanthanum active sites of SBA-15 exist in a relatively uniform hexagonal-open mesopore size distribution, excluding micro- and macropores, as is shown in FIG. 3C, the arsenate accessibility of lanthanum impregnated SBA-15 was much better than that of activated alumina. This is due to the fact that the activated alumina has amorphorous matrices of aluminum oxides that contain bottleneck-shaped pore structures which greatly hinder the accessibility of the active sites of the activated alumina to the arsenate molecules.

TABLE 2
Kinetic Parameters and Determination Coefficients (R²) of Pseudo-Second
Order Kinetic Model for Arsenate Adsorption Kinetics of Activated
Alumina (AA-400G, ALCAN ®) and SBA-15 Impregnated With Various
Weight Percentages of Lanthanum

Pseudo-Second-Order

| Media | ν₀^{a} | q₍ₗ₌₄₀₀₎ (mg · g⁻¹) | BET (m²/g) | R² |
|---|---|---|---|---|
| AA^{b} | 0.30 | 12.7 | 350˜380 | 0.965 |
| 10%^{c} | 0.31 | 23.9 | 486.20 | 0.964 |
| 20%^{c} | 1.21 | 55.4 | 450.79 | 0.988 |
| 50%^{c} | 1.71 | 124.4 | 276.03 | 0.997 |
| 80%^{c} | 1.53 | 115.4 | 184.65 | 0.994 |

^{a}initial sorption rate (mg · g⁻¹ · min⁻¹)
^{b}activated alumina (AA-400G, ALCAN ®)
^{c}percent lanthanum by weight of media impregnated into SBA-15

Arsenate adsorption isotherm tests were also conducted with activated alumina (AA-400G, ALCAN®), SBA-15, and La₅₀SBA-15 at an initial arsenate concentration of 20 mg/L and 50 mg/L. At an initial arsenate concentration of 20 mg/L, SBA-15 and activated alumina had arsenate adsorption capacities of less than 4.5 and 9 mg/g, respectively, while La₅₀SBA-15 exhibited an adsorption capacity of about 90 mg/g, which is approximately 20 and 10 times higher than the resulting adsorption capacities of SBA-15 and activated alumina, respectively. These results illustrate that the lanthanum oxide species incorporated onto the mesopore phase of SBA-15 are the most active sorption sites for arsenate removal of the three mediums tested. Moreover, similarly to the results of the kinetic studies, La₅₀SBA-15 showed much larger sorption capacity than activated alumina, although the absolute values of the sorption capacities obtained in the isotherm tests were different than those obtained as a result of the kinetic testing due to a different experimental setup in each test procedure. More specifically, with an increase of initial arsenate concentration from 20 mg/L to 50 mg/L, the adsorption capacity of La₅₀SBA-15 increased to 119.9 mg_{As}/g at 8.2 mg_{As}/L of equilibrium arsenate concentration. The qₘₐₓ values of the Langmuir model were used to get the values of arsenate adsorption density (mmol_{As}/mmol_{La}) and arsenate surface loading (mmol_{As}/m², BET). Using these values, compared to activated alumina, La₅₀SBA-15 had values about 9, 34, and 12 times higher for qₘₐₓ (mmol_{As}/g), arsenate adsorption density (mmol_{As}/mmol_{Me}), and surface loading (mmol_{As}/m²), respectively, demonstrating a close concordance with previous kinetic testing results. As shown in Table 3, isotherm testing results using La₅₀SBA-15 are compared with the results found in other studies in which lanthanum was impregnated onto an alumina or silica gel and tested in an isothermal procedure for arsenic removal. Although the results of other studies also showed no interference of other anions such as Cl⁻, Br⁻, I⁻, NO₃⁻, and SO₄²⁻ for arsenate removal, the adsorption capacity of 123.7 mg_{As}/g for La₅₀SBA-15 that was obtained at lower arsenate concentration of 50 mg_{As}/L in this study was about 10 or 14 times higher than the referenced adsorption capacity values for La(III) impregnated alumina, 12.9 mg_{As}/g, or La(III) impregnated silica gel, 8.8 mg_{As}/g, at 74.9 mg_{As}/L or 37.5˜150 mg_{As}/L of initial arsenate concentrations, respectively (Wasay et al., “Adsorption of fluoride, phosphate, and arsenate ions on lanthanum-impregnated silica gel,” 68 (3), Water Environment Research 295-300 (1996); Wasay et al., “Removal of Hazardous Anions from Aqueous Solutions by La(III)- and (Y)III-Impregnated Alumina,” 31 (10), Separation Science and Technology 1501-1514 (1996)).

TABLE 3
Determination Coefficients (R²), Several Parameters for
the Fit of Arsenate Adsorption Isotherm Data to
Langmuir Isotherms, and Comparisons with Other Studies

| Adsorption | | This study | | | References | |
|---|---|---|---|---|---|---|
| isotherms and | | Activated | | | La(III)- | La(III) |
| parameters | | alumina | La₅₀SBA-15 | | alumina^{a} | silica gel^{b} |
| As (V) conc. (mmol/L) | | 0.267 | 0.267 | 0.667 | 1 | 0.5˜2 |
| Langmuir | qₘₐₓ (mg/g) | 12.89 | 113.58 | 123.69 | 12.89 | 8.84 |
| | BET (m²/g) | 350˜380 | 276 | 276 | 45.1 | 293 |
| | R² | 0.976 | 0.993 | 0.922 | — | — |

^{a}lanthanum(III) impregnated alumina,
^{b}Lanthanum (III) impregnated silica gel.

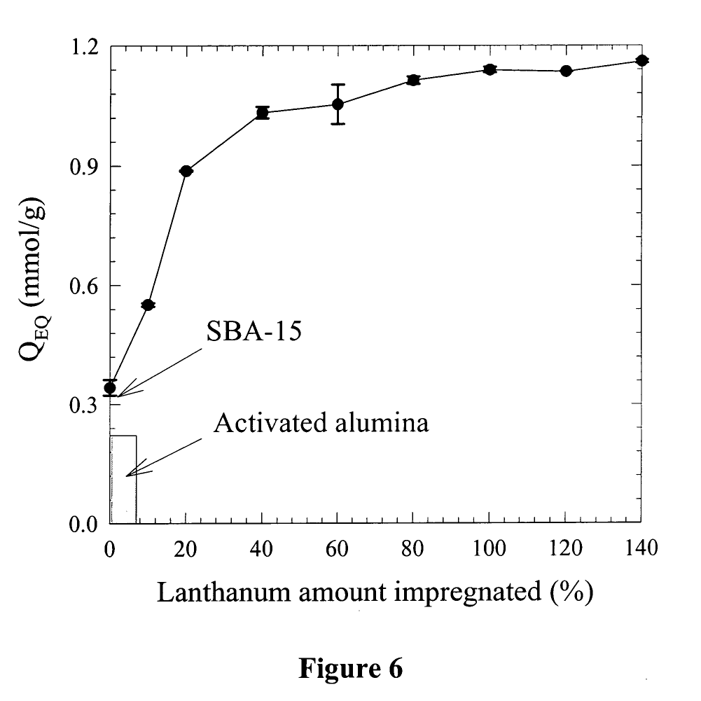

FIG. 6 describes the arsenate adsorption capacities with different impregnation percentages of lanthanum for SBA-15 in a solution with an initial arsenic concentration of 1.33 mmol/L or 100 mg/L. For this adsorption isotherm test, bottled water was used to determine the selectivity of arsenic adsorption for LaSBA-15. In the test procedure, the solution volume and mass of each adsorbent were 50 mL and 0.05 g, respectively. After 8 hrs of shaking, 5 mL of the suspension was withdrawn and filtered immediately with a 0.45-μm pre-rinsed Uniflo filter unit. The filtrate was analyzed for arsenate concentration of solution with AAS-graphite. Unaltered or unimpregnated SBA-15 had higher arsenic adsorption capacity than activated alumina. This result can be explained by the following mechanism. SBA-15 has negative charges in neutral pH condition because its PZC (pH of zero charge) is very low. So, cationic species such as Ca²⁺ and Mg²⁺ that are present in bottle water can be adsorbed onto the surface of SBA-15, such that the negatively charged arsenic is adsorbed onto the cationic species present on the SBA-15 surface. With increasing amounts of lanthanum impregnation, the SBA-15 media has an increase in the number of positive charges available to supply the active sites for adsorption of the arsenate. The arsenic adsorption capacity increased sharply in increases in impregnation from 0% to 40% lanthanum impregnation to about 75 mg/g or 1 mmol/g. However, impregnations of lanthanum in the SBA-15 media of higher than 40% by weight resulted in only small increases of the arsenic adsorption capacities for the media. Further, the adsorption capacities found for La₁₀SBA15 and La₂₀SBA-15 were very similar to the adsorption kinetic data of samples of the same media obtained in testing performed with deionized water spiked by 0.01 M NaNO₃. Therefore, it can be concluded that lanthanum impregnated SBA-15 has a very strong selectivity for arsenic because the adsorption capacities of the media do not deteriorate to any appreciable extent if one or more other anionic species, such as sulfate and nitrate, are found in high concentrations in bottled water along with arsenic.

Accordingly, the nano-scale impregnation of lanthanum onto SBA-15 has many advantages in terms of adsorption velocity and capacity, and also cost/benefit considerations for small scale POU/POE applications of arsenate removal. This is because only a small amount of the lanthanum precursor is needed for impregnation of the media, and the high level of regeneration possible for the lanthanum impregnated mesoporous media due to the enhancement of the structural stability of SBA-15 by the impregnated lanthanum.

Due to the high arsenic adsorption rate and capacity of the powdered lanthanum impregnated within the mesoporous media, it can also be surmised that granular lanthanum prepared in the previously recited manner will also have increased arsenic adsorption rates and capacities when used in the mesoporous media in comparison with current granular and block filter media. For this reason, it is also contemplated to use granular lanthanum in a mesoporous media for various POU/POE applications and wastewater treatment applications. Further, the powdered end granular lanthanum can also be incorporated into existing types of conventional filter media to increase the ability of these filter media to remove arsenic. For example, the powered or granular material impregnated in the mesoporous media can be used in combination with a conventional carbon block filter. Also, the granular and powdered lanthanum material can be mixed into the carbon used in forming the block filter, so that the carbon block and lanthanum material are formed as a unitary filter member.

Various alternatives are contemplated as being within the scope of the following claims particularly pointing out and distinctly claiming the subject matter regarded as the invention.

We hereby claim:

1. A filter material for removing a contaminant from a fluid stream comprising:
a) an ordered filter media; and
b) an additive impregnated into the filter media and capable of bonding to the contaminant.

2. The filter material of claim 1 wherein the additive is a metal oxide.

3. The filter material of claim 2 wherein the additive is selected from the group consisting of aluminum, iron, titanium and lanthanum.

4. The filter material of claim 2 wherein the additive is lanthanum.

5. The filter material of claim 1 wherein the additive is impregnated in an amount of between 5% and 140% by weight of the filter media.

6. The filter material of claim 1 wherein the contaminant is arsenic.

7. The filter material of claim 1 wherein the filter media is a mesoporous silica molecular sieve.

8. The filter material of claim 1 wherein the additive is in powder form.

9. The filter material of claim 1 wherein the additive is in granular form.

10. The filter material of claim 1 wherein the filter media and impregnated additive are combined with a conventional filter material.

11. The filter material of claim 10 wherein the conventional filter material is a carbon block.

12. The filter material of claim 1 wherein the fluid stream is a water stream.

13. The filter material of claim 1 wherein the fluid stream is a gas stream.

14. A filter material for removing a contaminant from a fluid stream comprising:
a) a conventional filter material; and
b) an additive intermixed with the conventional filter material, the additive including a metal oxide selected from the group consisting of aluminum, iron, titanium and lanthanum.

15. The filter material of claim 14 wherein the conventional filter material is a carbon block.

16. The filter material of claim 14 wherein the additive is in granular form.

17. A method for forming a filter material for removing a contaminant from a fluid stream, the method comprising the steps of:
a) forming an ordered filter media; and
b) impregnating an additive into the ordered filter media.

18. The method of claim 17 wherein the step of forming the ordered filter media comprises forming an ordered mesoporous silica molecular sieve.

19. The method of claim 17 wherein the step of impregnating the additive into the filter media is performed by an incipient wetness impregnation technique.

20. The method of claim 17 wherein the step of impregnating the additive into the filter media is performed by a wetness impregnation technique.

21. The method of claim 17 wherein the step of impregnating the additive comprises impregnating the additive into the filter media in an amount between about 5% and about 140% by weight of the filter media.

22. The method of claim 17 wherein the additive is selected from the group consisting of aluminum, iron, titanium and lanthanum.

23. The method of claim 17 wherein the additive is in powdered form.

24. The method of claim 17 wherein the step of forming the ordered filter media comprises forming an ordered mesoporous silica molecular sieve.

25. A method for removing a contaminant from a fluid stream comprising the steps of:
a) providing a filter material including a filter media intermixed with an additive, and
b) placing the filter media into the fluid stream.

26. The method of claim 25 wherein the additive is selected from the group consisting of aluminum, iron, titanium and lanthanum.

27. The method of claim 25 wherein the step of providing the filter media comprises the steps of:
a) forming a filter media; and
b) mixing the additive into the filter media.

28. The method of claim 27 wherein the step of forming the filter media comprises forming an ordered mesoporous molecular sieve.

29. The method of claim 28 wherein the step of mixing the additive comprises impregnating the additive into the sieve.

30. The method of claim 27 wherein the filter media is a carbon block.
